(19) United States
(12) Patent Application Publication
(10) Pub. No.: US 2025/0341268 A1
(43) Pub. Date: Nov. 6, 2025

(54) FIBER REINFORCED LAMINATE PIPE JOINT INSERT

(71) Applicant: Grant Prideco, Inc., Houston, TX (US)

(72) Inventors: Naveen M. Alva, Singapore (SG); Sriram Chandran, Singapore (SG); Gino Davis Vadakkethala, Kuala Lampur (MY); Muhammad Asyraf Bin Abd Talib, Johor Darul Takzim (MY)

(21) Appl. No.: 18/653,519

(22) Filed: May 2, 2024

(51) Int. Cl. F16L 13/10; F16L 9/08

(52) U.S. Cl. CPC F16L 13/103; F16L 9/085

(57) ABSTRACT

A fiber reinforced laminate pipe joint can include a first pipe, a second pipe, where the first pipe and the second pipe can be fiber reinforced laminate pipes, and a pipe joint insert. The pipe joint insert can be partially inserted inside the first pipe and can be partially inserted inside the second pipe. The pipe joint insert can be bonded to the first pipe and the second pipe, where the pipe joint insert can include a fiber reinforced laminate, where a bonding agent in the fiber reinforced laminate of the pipe joint insert can be distinct from a bonding agent used to bond the pipe joint insert to the first pipe.

### TECHNICAL FIELD

The present disclosure relates to pipe. More particularly, the present disclosure relates to composite pipes. Still more particularly, the present disclosure relates to systems and methods for joining composite pipes.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Pipes can be used to transport one or more of liquids, gasses, and slurries. A pipe may include a wall for containing the transportable material, and a bore for carrying the transportable material. The wall may include one or more materials that are connected by one or more of glue, fusing, or mechanical bonding. A composite pipe (e.g., a fiber reinforced laminate pipe) can be manufactured using a bonding agent (e.g., a resin (e.g., epoxy resin, polyester resin, vinylester resin)) combined with a fiber (e.g., fiberglass). Two pipes can be joined together to produce a longer pipe, introduce a fitting (e.g., an elbow, a size-changing fitting), or both.

In an approach, joining two pipes can include aligning two pipes to be joined, laminating the inside of the joint, and laminating the outside of the joint. The lamination process can include using a resin and a reinforcing material to bond and strengthen the joint. The lamination process can be performed at least partially manually. In an example, the inner lamination can be performed by having a human worker enter the first pipe or the second pipe to manually perform the inner lamination after the pipes have been aligned. This can be one or more of time-consuming or difficult. In some cases, internal lamination can be prohibitively difficult (e.g., in a case where the pipes are oriented vertically, in a case where the pipe diameter does not allow a human worker to enter the pipe joints).

### SUMMARY

In an example, a fiber reinforced laminate pipe joint can include a first pipe, a second pipe, where the first pipe and the second pipe can be fiber reinforced laminate pipes, and a pipe joint insert. The pipe joint insert can be partially inserted inside the first pipe and can be partially inserted inside the second pipe. The pipe joint insert can be bonded to the first pipe and the second pipe, where the pipe joint insert can include a fiber reinforced laminate, where a bonding agent in the fiber reinforced laminate of the pipe joint insert can be distinct from a bonding agent used to bond the pipe joint insert to the first pipe.

In an example, a fiber reinforced laminate pipe joint intermediate can include a first fiber reinforced laminate pipe and a fiber reinforced laminate pipe insert. An outer diameter of a radially outer surface of the fiber reinforced laminate pipe insert can be configured to interface with an inner diameter of the first fiber reinforced laminate pipe, where the fiber reinforced laminate pipe insert can be partially inserted into the first fiber reinforced laminate pipe and bonded in place, where a portion of the fiber reinforced laminate pipe insert can extend outside of the first fiber reinforced laminate pipe.

In an example, a method of joining a first fiber reinforced laminate pipe to a second fiber reinforced laminate pipe can include partially inserting a fiber reinforced laminate pipe insert into the first fiber reinforced laminate pipe and bonding the fiber reinforced laminate pipe insert in place. The method can also include partially inserting the fiber reinforced laminate pipe insert into the second fiber reinforced laminate pipe and bonding the fiber reinforced laminate pipe insert in place.

### BRIEF DESCRIPTION OF THE DRAWINGS

In the drawings, which may not be drawn to scale, like numerals may describe substantially similar components throughout one or more of the views. Like numerals having different letter suffixes may represent different instances of substantially similar components. The drawings illustrate generally, by way of example but not by way of limitation.

FIG. 1 shows an example of fiber reinforced laminate pipe.

FIG. 2 shows a cutaway perspective view of an example of a pipe joint.

FIG. 3 shows a perspective view of an example of a pipe joint insert.

FIG. 4 shows a perspective view of an example of the pipe joint of FIG. 2 viewed looking into the second pipe.

FIG. 5 shows a cutaway perspective view of an example of a pipe joint which can include a pipe to elbow joint.

FIG. 6 shows a cutaway perspective view of an example of a pipe joint which can include a pipe to Tee joint.

FIG. 7 shows a cutaway perspective view of an example of a pipe joint which can include a pipe to reducer joint.

FIG. 8 shows a cutaway perspective view of an example of a pipe joint which can include an elbow miter joint.

FIG. 9 shows a cutaway perspective view of an example of a pipe joint which can include a Tee miter joint.

FIG. 10 shows a cutaway perspective view of an example of a pipe joint which can include a reducer miter joint.

FIG. 11 shows a perspective view of an example of portions of the pipe joint of FIG. 2 including the first pipe and pipe joint insert.

FIG. 12 shows a perspective view of an example of portions of the pipe joint of FIG. 2 including the first pipe, the second pipe, and pipe joint insert.

FIG. 13 shows a perspective view of an example of portions of the pipe joint of FIG. 2 including the first pipe, the second pipe, the pipe joint insert, and a portion of the external lamination.

FIG. 14 shows a perspective view of an example of portions of the pipe joint of FIG. 2 including the first pipe, the second pipe, the pipe joint insert, and the external lamination.

FIG. 15 shows an example of portions of a method for forming a pipe joint.

### DETAILED DESCRIPTION

The present disclosure, in one or more examples, relates to a pipe joint insert that can be used in a joint between two pipes. The insert can be particularly suitable for fiber reinforced laminate pipes.

In an example, a pipe joint insert can be used as an alternative to or in conjunction with laminating the inside of the joint. The insert can include a substantially rigid cylindrical insert and can help to align the pipes to be joined, help to strengthen or otherwise tailor the properties of the pipe joint, or both. The pipe joint insert can remove a need for an internal lamination or it can strengthen a pipe joint formed using an internal lamination. Additionally, internal lamination can be undesirable because the fiber must stick to the radially inner surfaces of the pipes, and no or little tension can be placed on the fiber. This can result in a weaker or more unpredictable joint. The pipe joint insert can be of laminated construction similar to the pipe itself or it can be constructed from other materials or methods. The pipe joint insert can be bonded to the pipes to be joined. This can occur before and/or during fitting the pipes and can remove a need for a worker to manually access the inner side of the pipe joint.

The fiber reinforced laminate pipes can be spoolable pipes or rigid pipes. Spoolable pipe may be desirable because it may be lightweight, flexible, easy to install, and/or cost-saving. A length of spoolable pipe may be able to be stored and transported in one piece on a spool or reel, for example. The length of spoolable pipe on the reel may be able to be installed in one continuous piece without joints, such as by unwinding the pipe from a spool. The pipe from two or more spools can be combined using joints, or the spoolable pipe can be joined to another piping element (e.g., a rigid pipe, an elbow, etc.). This may save time, save installation cost, allow installation where otherwise impractical, or result in a stronger installation. Rigid pipe may be desirable because it may be more robust and/or more compact to transport than spoolable pipe. Rigid plastic pipe may be transported in a number of rigid sections of a specified length. During installation, respective rigid sections may be glued, bonded, or otherwise joined together to form a longer section of pipe. Rigid pipe may be able to be manufactured in a larger diameter than spoolable pipe.

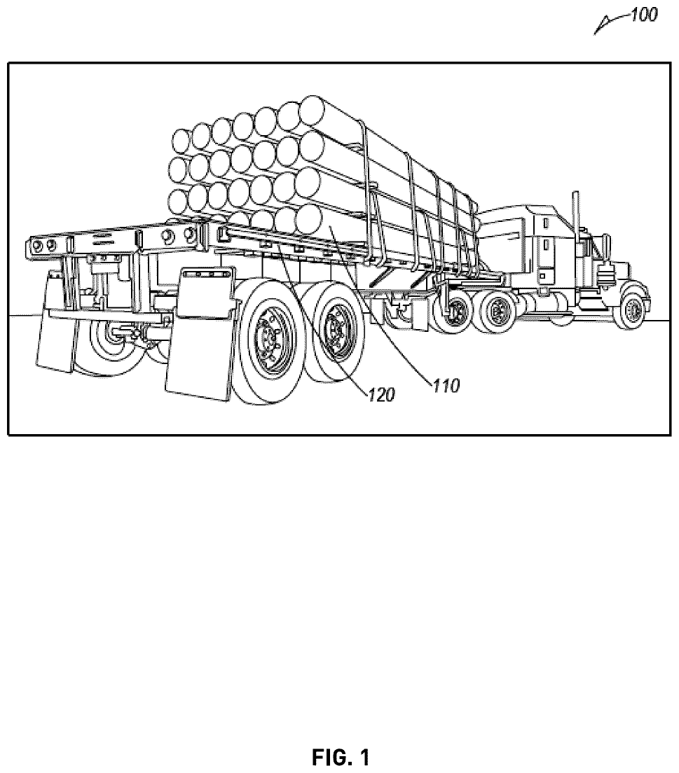

FIG. 1 shows an example 100 of using pipe 110. FIG. 1 shows pipe 110 being transported in straight sections on a trailer 120. The trailer 120 contains a number of sections of pipe 110 of a specified length. The sections of pipe 110 may be joined during installation using one or more of glue or another means of bonding (e.g., using a joint of the present disclosure, using a pipe joint insert of the present disclosure).

In an example, the pipe 110 may be a flexible spoolable pipe transported on a spool. The length of pipe 110 may be continuous on the spool, which may allow the entire length of pipe 110 to be installed without connections or joints. The spool may be stored on a portable trailer which may allow the pipe to be transported from a location of storage or manufacturing to the location of installation and may provide for moving the spool along the installation site while the pipe 110 is being unwound off of the spool. The pipe 110 may be flexible to allow the pipe 110 to be spooled on and off the spool. The diameter of the spool may be selected to allow the pipe 110 to be spooled without damaging the pipe 110.

The pipe 110 may have a selected strength and durability, such as may allow the pipe 110 to be used in harsh environments. The pipe 110 may be used to carry a variety of liquids, gasses, and slurries. In an example, the pipe may carry water, including a mixture of water and other chemicals.

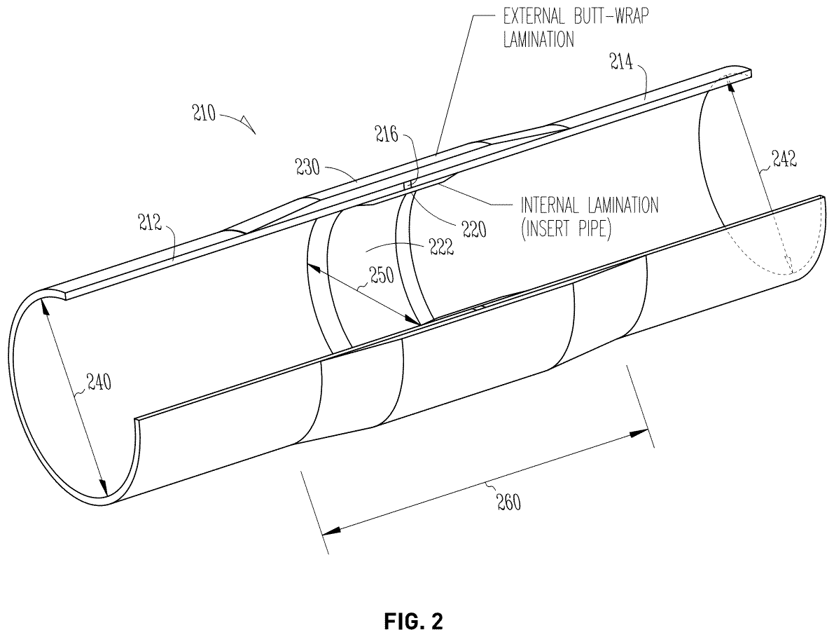

FIG. 2 shows a cutaway perspective view of an example of portions of a pipe joint 210. FIG. 2 shows that the pipe joint 210 can include a first pipe 212, a second pipe 214, a pipe joint insert 220, and an external lamination 230.

The first pipe 212 can be a fiber reinforced laminate pipe. The first pipe 212 can be configured for carrying a flow of one or more materials. The first pipe 212 can have an inner diameter 240. The first pipe 212 can be configured such that the inner diameter 240 has any value, such as can include two inches, four inches, eight inches, 16 inches, 30 inches, 45 inches, 60 inches, or any other value. The wall of the first pipe 212 can have any thickness. The thickness of the wall can be selected based on one or more of a desired operating pressure, a desired rigidity, and/or a desired weight of the first pipe 212. The first pipe 212 can have a shape that is substantially consistent across its entire length, or across a portion of the first pipe 212 that is near the pipe joint 210. For example, the portion of the first pipe 212 that is included in the pipe joint 210 may not be specifically configured for inclusion in a joint, and may match the remainder of the first pipe 212. The first pipe 212 can be cut to a specified length, such as in the field, and then joined to the second pipe 214. In an example, the portion of the first pipe 212 included in the pipe joint 210 can be configured for inclusion in a joint. For example, the end of the first pipe 212 included in the pipe joint 210 could be reinforced (e.g., thicker walls), tapered, or both.

The second pipe 214 can be configured similarly to the first pipe 212, or can differ in one or more ways. The second pipe 214 can be configured for carrying a flow of one or more materials. The inner diameter 242 of the second pipe 214 can match the inner diameter 240 of the first pipe 212, or the second pipe 214 can have an inner diameter 242 that is different from the first pipe 212. In an example, both the first pipe 212 and the second pipe 214 are fiber reinforced laminate pipes. The inner diameter 240, the inner diameter 242, or both, can have be any value. In an example, an inner diameter 240 of the first pipe and an inner diameter 242 the second pipe can be less than 30 inches, which can include a diameter of between 1 inch and 30 inches.

In an example, the first pipe 212, the second pipe 214, or both have an internal diameter that is substantially consistent across a longitudinal length 260 of the pipe joint 210 and for a specified margin on either side of the pipe joint 210. The longitudinal length 260 can include a longitudinal length of the pipe joint insert 220 or the external lamination 230, which can include whichever of the pipe joint insert 220 or the external lamination 230 has a larger longitudinal length. In this example, one or more of the first pipe 212 and the second pipe 214 can be field cut, to provide for constructing the pipe joint 210 at any point along a length of the first pipe 212 or the second pipe 214.

The pipe joint insert 220 can be positioned inside the pipe joint 210. The pipe joint insert 220 can be configured to help align the first pipe 212 with the second pipe 214 during construction of the pipe joint 210, form a portion of the pipe joint 210 (e.g., a structural portion, such as to increase a strength of the pipe joint 210, a sealing portion, such as to help seal the pipe joint 210), or both. The pipe joint insert 220 can be inserted partially inside the first pipe 212. The pipe joint insert 220 can be inserted partially inside the second pipe 214. The pipe joint insert 220 can be inserted partially into both the first pipe 212 and the second pipe 214. The pipe joint insert 220 can be evenly spaced between the first pipe 212 and the second pipe 214, or can be shifted towards one of the pipes. The pipe joint insert 220 can be bonded to the first pipe 212, which can include bonding a portion of the pipe joint insert 220 inserted into the first pipe 212 (e.g., all of the portion of the pipe joint insert 220 that is inserted into the first pipe 212, a portion of the portion of the pipe joint insert 220 that is inserted into the first pipe 212) to the first pipe 212. The pipe joint insert 220 can be bonded to the second pipe 214, which can include bonding a portion of the pipe joint insert 220 inserted into the second pipe 214 to the second pipe 214. The pipe joint insert 220 can have a uniform thickness across a length of the pipe joint insert 220, or can be tapered on one or both ends, as shown in FIG. 2.

The first pipe 212 can meet the second pipe 214 at the pipe interface 216 (e.g., the free end of the first pipe 212 and the free end of the second pipe 214 can generally meet at the pipe interface 216), such as can extend radially around the pipe joint 210 (e.g., 360 degrees around the pipe joint 210). There can be a gap between the first pipe 212 and the second pipe 214 at the pipe interface 216, such as can be filled with a bonding agent or the ends of the pipes can abut one another.

The external lamination 230 can cover a portion of the first pipe 212, a portion of the second pipe 214, or both. The external lamination 230 can cover the pipe interface 216. The external lamination 230 can be configured to strengthen or otherwise tailor a property of the pipe joint 210, help seal the pipe joint 210 (e.g., in conjunction with the pipe joint insert 220), or both. In an example, the external lamination 230 can be omitted. In this example, the first pipe 212 and the second pipe 214 can be connected through the pipe joint insert 220, such as through the pipe joint insert 220 and bonding agent in the pipe interface 216 alone. For example, the first pipe 212 can be bonded to the pipe joint insert 220 along a portion of the area where the pipe joint insert 220 is inserted into the first pipe 212. The first pipe 212 can be bonded to the second pipe 214 along a portion of the pipe interface 216. The second pipe 214 can be bonded to the pipe joint insert 220 along a portion of the area where the pipe joint insert 220 is inserted into the second pipe 214. In this example, the strength of the pipe joint insert 220 (e.g., which is bonded to both the first pipe 212 and the second pipe 214) and the strength of the bond between the first pipe 212 and the second pipe 214 (e.g., in the pipe interface 216) can provide strength to the pipe joint 210. In the example where the pipe joint 210 includes an external lamination 230, the external lamination 230 can be bonded to both of the first pipe 212 and the second pipe 214. The external lamination 230 can add to the strength of the pipe joint 210.

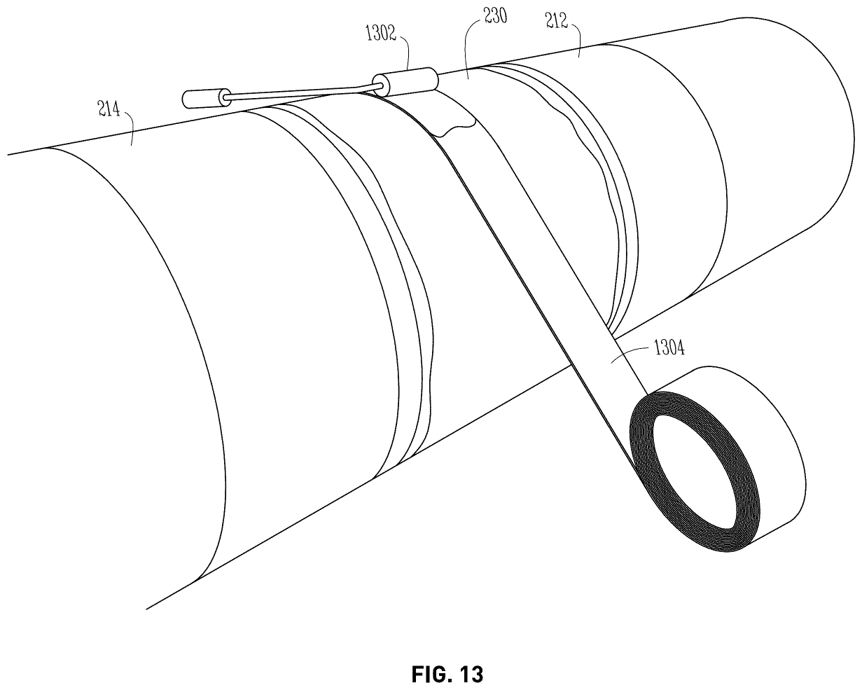

The external lamination 230 can include a fiber or fiber reinforced fabric 1304 and a resin 1302 (e.g., discussed with respect to FIG. 13). For example, the external lamination 230 can be formed by applying resin 1302 to the outside of the first pipe 212 and second pipe 214 and wrapping fiber or fiber reinforced fabric 1304 around the pipe joint 210. The external lamination 230 can be formed in an iterative or layered process, which can include multiple wraps of fiber or fiber reinforced fabric 1304, multiple applications of resin 1302, or both. The external lamination 230 can have a uniform thickness across a longitudinal length 260 of the pipe joint 210, or can be tapered on one or both ends, as shown in FIG. 2.

The pipe joint insert 220 can be a substantially rigid fiber reinforced laminate apparatus defining a bore. The bore can be configured for carrying a flow of one or more materials. The bore can be configured to allow a flow of material through the pipe joint 210, such as with minimal disruption (e.g., the pipe joint insert 220 can be configured such that the flow constriction caused by the pipe joint 210 is below a threshold).

The pipe joint insert 220 can be manufactured of any material. In an example, the pipe joint insert 220 can be manufactured from any material, which can include plastics, metals, ceramics, etc. The pipe joint insert 220 can include a laminate construction, such as including a resin and a fiber material. In an example, one or more of the first pipe 212, the second pipe 214, the pipe joint insert 220, or the external lamination 230 can include one or more of a fiberglass material, a carbon fiber material, an epoxy resin, a polyester resin, or a vinylester resin.

The pipe joint insert 220 can have an outer diameter 250 that is configured to interface with the inner diameter 240 of the first pipe and an inner diameter 242 of the second pipe. For example, the outer diameter 250 can be configured to match one or more of the inner diameter 240 or inner diameter 242, such as match within a specified tolerance. In an example, the outer diameter 250 can be configured to provide a specified level of friction between the inner diameter 240 or the inner diameter 242, which can include the outer diameter 250 being smaller or larger than the inner diameter 240 or the inner diameter 242.

The pipe joint insert 220 can include a fiber reinforced laminate. A bonding agent in the fiber reinforced laminate of the pipe joint insert 220 can be distinct from a bonding agent that can be used to bond the pipe joint insert 220 to the first pipe 212, the second pipe 214, or both. For example, the bonding agent in the pipe joint insert 220 can form a distinct layer from the bonding agent used to bond the pipe joint insert 220 to the first pipe 212, such as due to the bonding agent in the pipe joint insert 220 at least partially curing (e.g., fully curing, tacking, curing to a specified percentage) before the bonding agent between the pipe joint insert 220 and the first pipe 212 is applied. The layer between the pipe joint insert 220 that was bonded at the time the pipe joint 210 is assembled and the bonding agent used in the pipe joint 210 can form a perceptible interface layer. The bonding agent in the pipe joint insert 220 can be the same configuration of bonding agent (e.g., epoxy, polyester, quick cure, slow cure) as is used in one or more of the first pipe 212, the second pipe 214, or the pipe joint insert 220, or can differ in one or more properties. For example, the first pipe 212, the second pipe 214, and the pipe joint insert 220 can include an epoxy resin, and the bonding agent used in the pipe joint 210 can include an epoxy resin.

In an example, the bonding agent can form a structural portion of the pipe joint 210 (e.g., adhesive bonding, such as without chemically altering the substrates). For example, a portion or all of the strength of the pipe joint 210 can be generated by the bonding agent. In an example, the bonding agent can cause one or more materials in the first pipe 212, the second pipe 214, or the pipe joint insert 220 to fuse together (e.g., the bonding agent induces a chemical reaction causing the first pipe 212, the second pipe 214, or the pipe joint insert 220 to fuse together (e.g., bond chemically or electronically, such as in a solvent welding process)). In this example, the bonding agent may not generate a portion of the strength of the joint, or can generate a smaller portion of the strength as compared to a structural bonding agent.

A resin in the pipe joint insert 220 can be fully cured before the pipe joint insert 220 is used in the pipe joint 210. For example, the pipe joint insert 220 can be manufactured before the pipe joint 210 is formed. This can be in contrast to the external lamination 230, which can be formed after the pipe joint 210 is partially formed. The pipe joint insert 220 can be continuous along an internal circumference. In an example, the pipe joint insert 220 may not be composed of individual strips of fiber material.

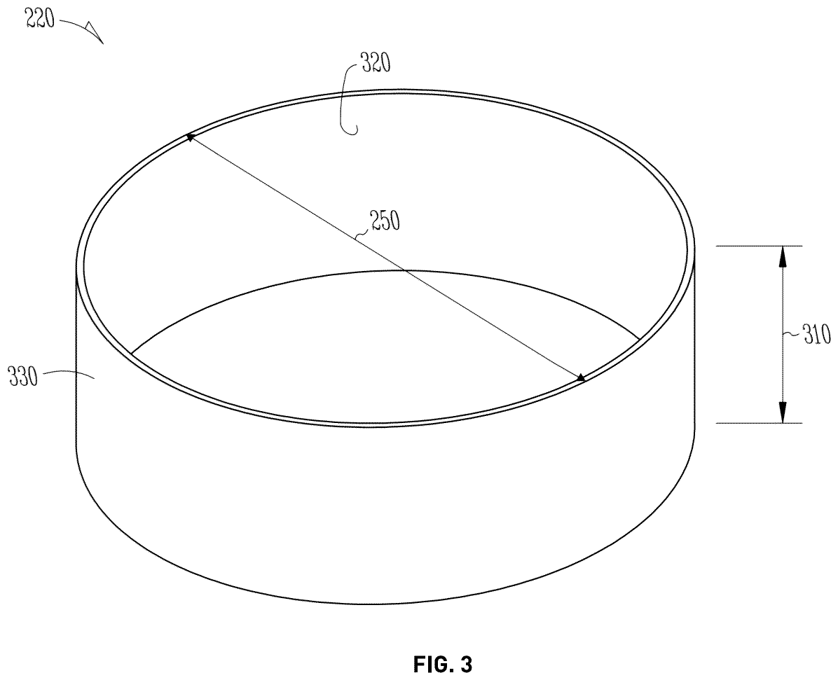

FIG. 3 shows a perspective view of an example of portions of a pipe joint insert 220. FIG. 3 shows that the pipe joint insert 220 can include a radially inner surface 320 and a radially outer surface 330. FIG. 3 shows that the pipe joint insert 220 can have an outer diameter 250, and a longitudinal length 310. The radially inner surface 320 can define a bore. The radially outer surface 330 can define the outer diameter 250.

The outer diameter 250 of the radially outer surface 330 can be configured to interface with an inner diameter of a first pipe and a second pipe (e.g., the first pipe 212 and the second pipe 214) in a pipe joint (e.g., the pipe joint 210). In an example, the first pipe and the second pipe are fiber reinforced laminate pipes.

The pipe joint insert 220 can be circular in cross-section. For example, the outer diameter 250 can be substantially the same regardless of the radial position the outer diameter 250 is measured at. The radially outer surface 330 of the pipe joint insert 220 can be substantially smooth, or can have a specified level of texture or roughness. The radially outer surface 330 can include a surface configured to increase a bond strength, such as can include a surface with a specified texture, exposed fibers, or both. In an example, the radially outer surface 330 can include a ridge that is configured to be positioned in the pipe interface 216, such as to prevent the pipe joint insert 220 from inserting into the first pipe 212 or the second pipe 214 beyond the ridge. In an example, the pipe joint insert 220 may not include a ridge, such as can allow the pipe joint insert 220 to be inserted into the first pipe 212 or the second pipe 214 as far as desired. The radially inner surface 320 can be configured to allow fluid to flow across the radially inner surface 320, such as can include the radially inner surface 320 having a substantially smooth texture.

In an example, the longitudinal length 260 of the pipe joint insert can be at least one-half of the outer diameter 250 of the radially outer surface 330. This can provide a particular degree of stability when the pipe joint insert 220 is inserted into a pipe (e.g., if the longitudinal length 260 is decreased, the pipe joint insert 220 may have a higher tendency to become bound, stuck, or misaligned).

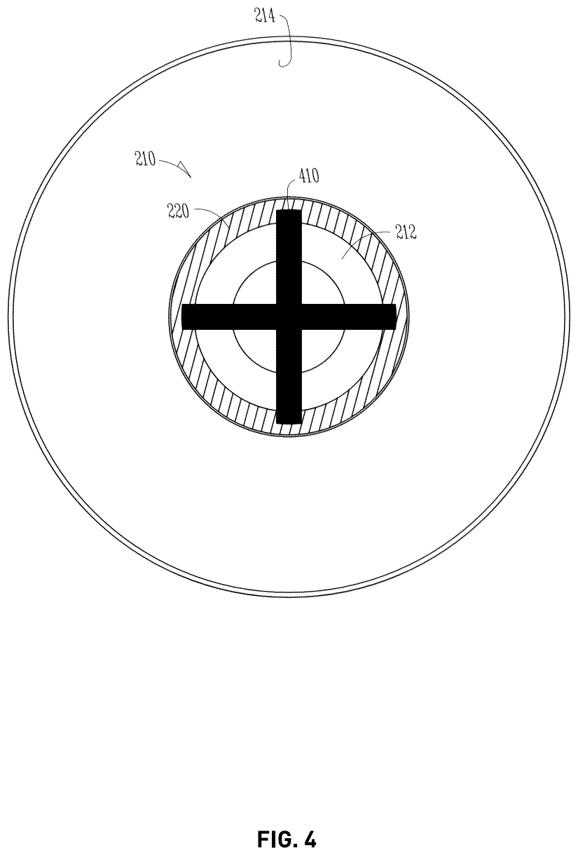

FIG. 4 shows a perspective view of an example of portions of a pipe joint 210. FIG. 4 shows the pipe joint 210 through the bore of the second pipe 214. FIG. 4 shows that the pipe joint insert 220 can have a smaller inner diameter than the second pipe 214 and the first pipe 212. FIG. 4 shows that the pipe joint 210, can include a support member 410. The support member 410 can be configured to support the pipe joint insert, the pipe joint 210, or both, such as during the forming of the pipe joint 210. For example, the support member 410 can support the pipe joint insert 220 when the pipe joint insert 220 is being inserted into the first pipe 212 or the second pipe 214. The pipe joint insert 220 may have a large diameter, a thin wall, or both, such as can result in the pipe joint insert 220 becoming elliptical instead of circular in cross section, such as due to the force of gravity. The support member 410 can be configured to press against the radially inner surface 320 of the insert 220. The support member 410 can have one or more arms (e.g., as shown in FIG. 4 or with more or fewer arms), or can be a circular support. The support member 410 can be configured to be removed from the pipe joint insert 220. For example, the support member 410 can be removed after the pipe joint 210 is formed.

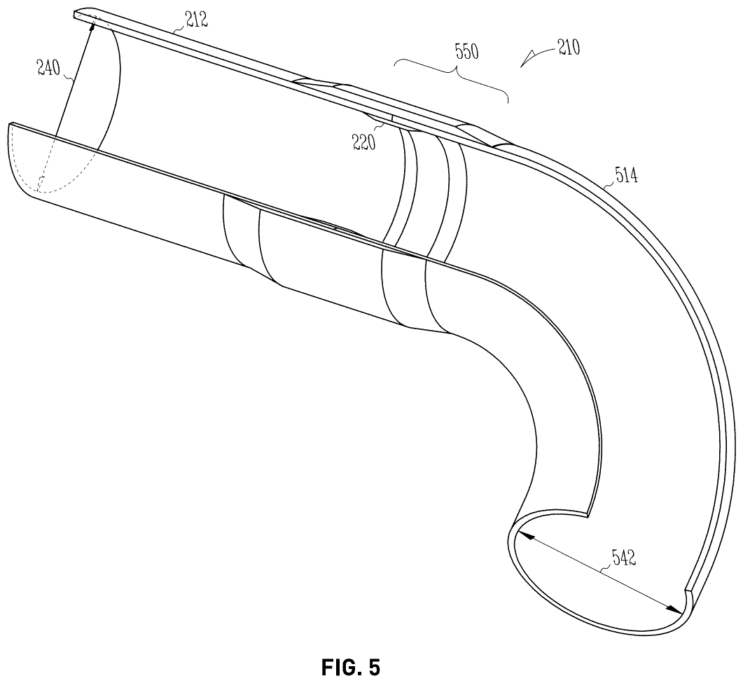

FIG. 5 shows a cutaway perspective view of an example of a pipe joint 210. In the example of FIG. 5, the second pipe in the joint (e.g., replacing the second pipe 214) can include an elbow 514. The pipe joint 210 can be configured similarly to the pipe joint 210 of one or more of FIG. 2, FIG. 3, or FIG. 4, or can differ in one or more ways. The pipe joint 210 can include a pipe joint insert 220.

FIG. 5 shows that the elbow 514 can have an inner diameter 542 that is substantially consistent across the length of the elbow 514. In an example, the inner diameter 542 can vary (e.g., increase, decrease) at or along one or more portions of the elbow 514. FIG. 5 shows that the elbow 514 can have an inner diameter 542 that is substantially the same as the inner diameter 240 of the first pipe 212. FIG. 5 shows that the elbow 514 can include a straight portion 550 near the pipe joint 210, which can allow the pipe joint 210 to configured similarly to the pipe joint 210 of one or more of FIG. 2, FIG. 3, or FIG. 4 (e.g., the straight portion 550 can replicate the portion of the second pipe 214 that is used in the pipe joint 210 of FIG. 2).

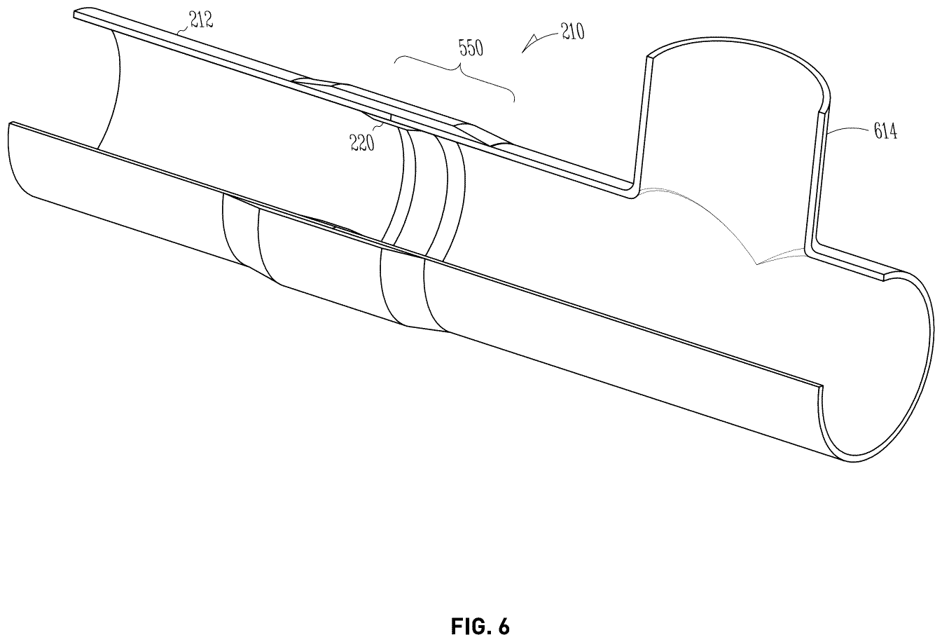

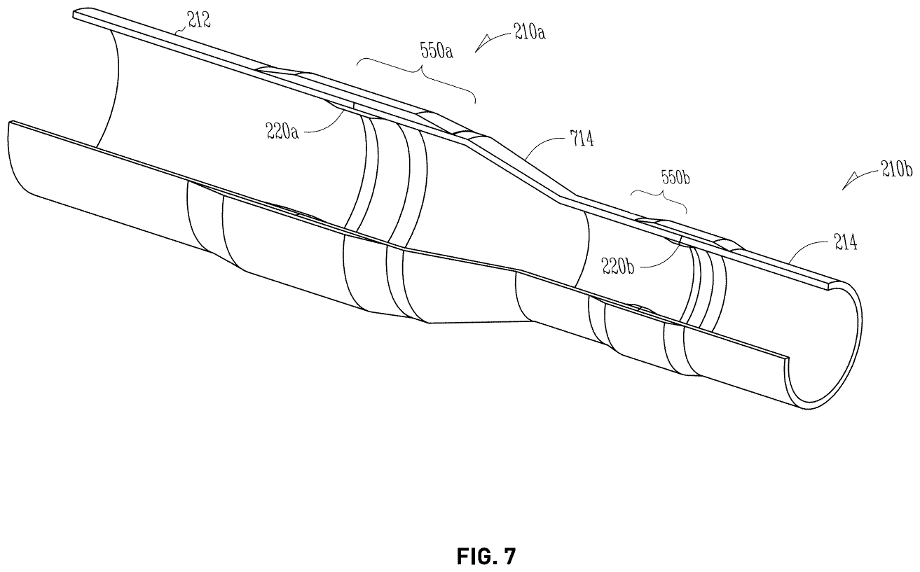

In an example, the second pipe can include any configuration of fitting, which can include an elbow (e.g., as shown and discussed above with respect to FIG. 5), a Tee (e.g., as shown and discussed below with respect to FIG. 6) a reducer (e.g., as shown and discussed below with respect to FIG. 7), or another type of fitting (e.g., Y-fitting, a cap) or pipe element (e.g., a valve, a flange). The pipe joint 210 of one or more of these examples can be configured similarly to the pipe joint 210 of one or more of FIG. 2, FIG. 3, FIG. 4, or FIG. 5. For example, one or more of these examples can include a straight portion 550 that allows the fitting to replicate the portion of the second pipe 214 used in the pipe joint 210 of one or more of FIG. 2, FIG. 3, or FIG. 4.

FIG. 6 shows a cutaway perspective view of an example of a pipe joint 210, where the second pipe can include a Tee 614. The Tee 614 can be any configuration of T. The pipe joint 210 can include a pipe joint insert 220.

FIG. 7 shows a cutaway perspective view of an example of a pipe joint 210a and a pipe joint 210b where one or more of the first pipe or the second pipe can include a reducer 714. The pipe joint 210a can be arranged on first end of the reducer 714 and the pipe joint 210b can be arranged on a second end of the reducer 714. One or more of the pipe joint 210a or the pipe joint 210b can be configured similarly to one or more of the other pipe joints 210 discussed herein. The pipe joint 210a can include a pipe joint insert 220a and the pipe joint 210b can include a pipe joint insert 220b. The reducer 714 can include a first straight portion 550a which can be partially included in the pipe joint 210a and can include a second straight portion 550b which can be partially included in the pipe joint 210b.

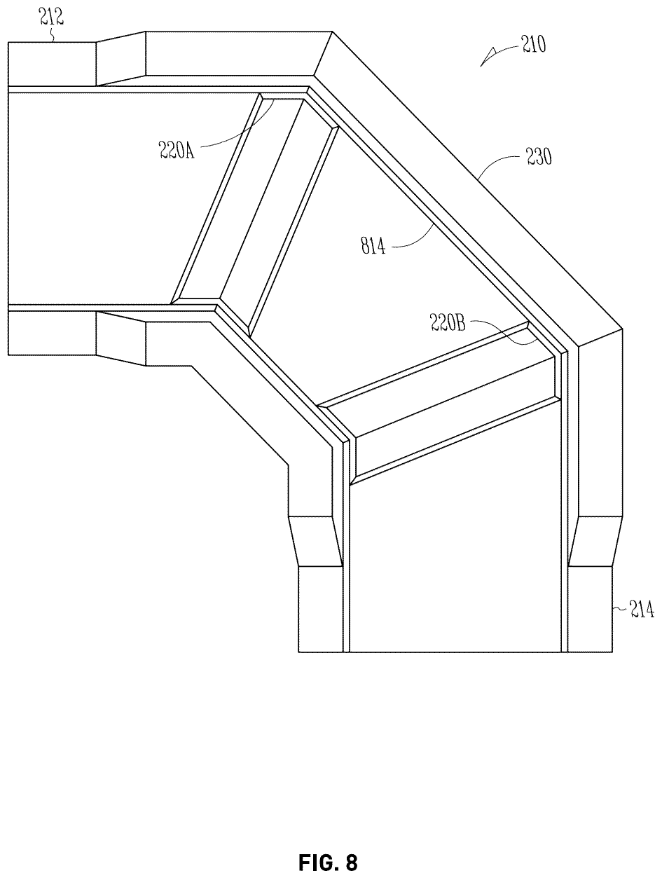

FIG. 8 through FIG. 10 show pipe joints 210 (e.g., including pipe joint inserts 220) that can include mitered pipe portions. In the examples of one or more of FIG. 8 through FIG. 10, one or more of the first pipe 212 or the second pipe 214 can include mitered pipe portions. A mitered pipe portion can include a portion of pipe that is cut in a way other than cutting all of the way through the pipe in a plane perpendicular to the longitudinal axis of the pipe, cut at a location where a diameter of the pipe is changing, or both.

FIG. 8 shows a cutaway perspective view of an example of a pipe joint 210. In the example FIG. 8, the pipe joint 210 can include a mitered elbow pipe joint. The pipe joint 210 can include a first pipe 212, a mitered pipe portion 814, and a second pipe 214, a first pipe joint insert 220a, a second pipe joint insert 220b, and an external lamination 230. One or more of the first pipe 212, the mitered pipe portion 814, or the second pipe 214 can include a mitered pipe portion. The first pipe 212 can be mitered to include a first angle. The mitered pipe portion 814 can be mitered to include one or more of a second angle on a first end and a third angle on a second end. The second pipe 214 can be mitered to include a fourth angle. In an example, the angle between the first pipe 212 and the second pipe 214 can be 90 degrees. In this example, the first pipe 212 and the first end of the mitered pipe portion 814 can form a 45 degree angle and the second end of the mitered pipe portion 814 and the second pipe 214 can form a 45 degree angle.

FIG. 8 shows that the pipe joint insert 220a, the pipe joint insert 220b, or both, can be mitered pipe joint inserts, which can be configured to match a shape of the inner diameter of the respective pipe portions (e.g., the pipe joint insert 220a can be configured to match a shape of the inner diameter of the first pipe 212 and the mitered pipe portion 814 that the pipe joint insert 220a contacts). For example, the pipe joint insert 220a and/or the pipe joint insert 220b may not be straight. One or more of the pipe joint insert 220a or the pipe joint insert 220b can be configured similarly to other pipe joint inserts 220 discussed herein, such as discussed with respect to one or more of FIG. 2, FIG. 3, or FIG. 4, or can differ in one or more ways.

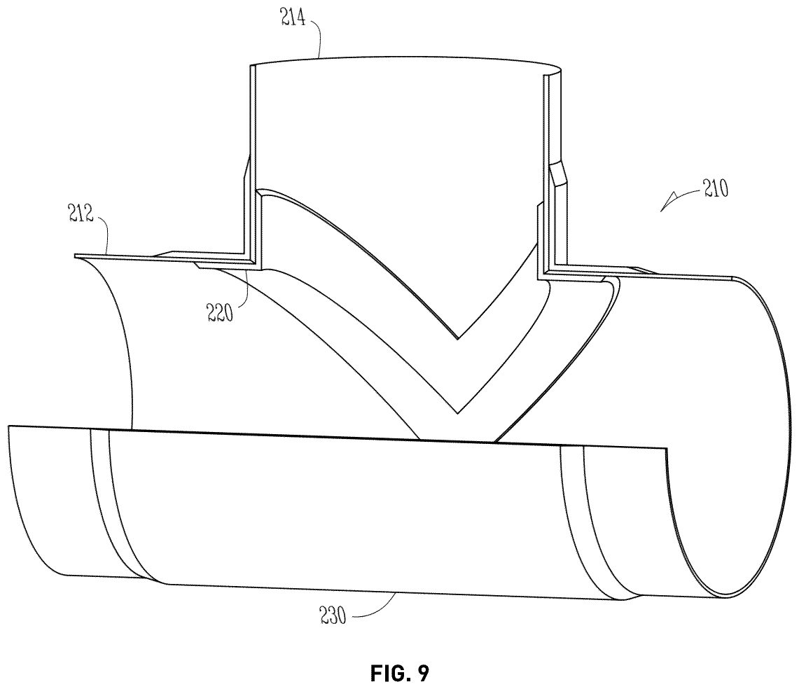

FIG. 9 shows a cutaway perspective view of an example of a pipe joint 210. In the example of FIG. 9, the pipe joint 210 can include a mitered Tee pipe joint. The pipe joint 210 can include a first pipe 212, a second pipe 214, a pipe joint insert 220, and an external lamination 230. One or more of the first pipe 212, or the second pipe 214 can include a mitered pipe portion. The first pipe 212 can be mitered to include an opening. The second pipe 214 can be mitered to include a shape that is configured to interface with the mitered opening in the first pipe 212. In the example of FIG. 9, the mitered Tee can be a 90 degree Tee. However, the Tee can be configured to have any angle.

FIG. 9 shows that the pipe joint insert 220 can be a mitered pipe joint insert, which can be configured to match a shape of the inner diameter of the respective pipe portions. The pipe joint insert 220 may not be straight. The pipe joint insert 220 can be configured similarly to other pipe joint inserts 220 discussed herein, such as discussed with respect to one or more of FIG. 2, FIG. 3, or FIG. 4, or can differ in one or more ways.

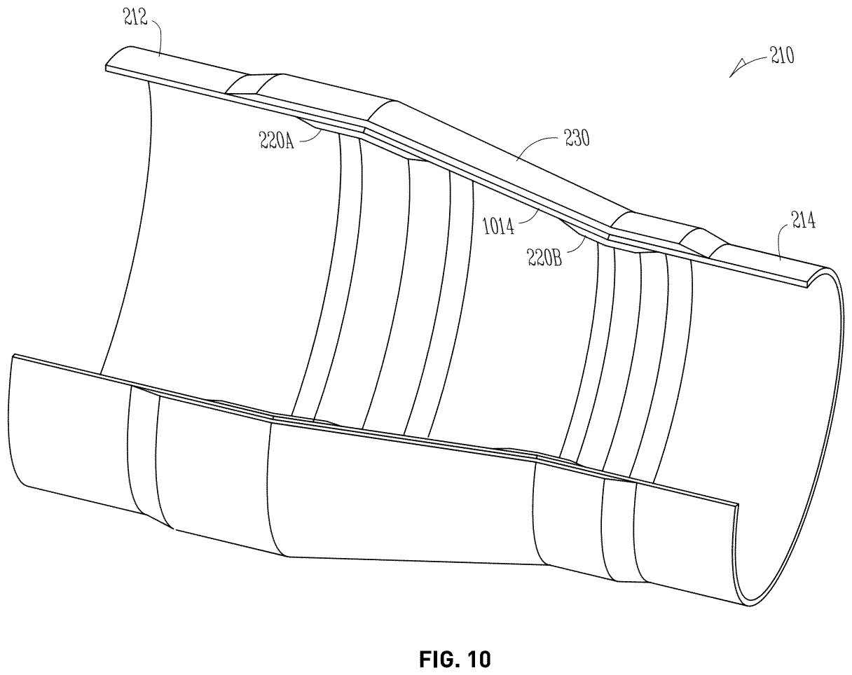

FIG. 10 shows a cutaway perspective view of an example of a pipe joint. In the example of FIG. 10, the pipe joint 210 can include a mitered reducer pipe joint. The pipe joint 210 can include a first pipe 212, a mitered pipe portion 1014, and a second pipe 214, a first pipe joint insert 220a, a second pipe joint insert 220b, and an external lamination 230. One or more of the first pipe 212, the mitered pipe portion 1014, or the second pipe 214 can include a mitered pipe portion. In an example, the first pipe 212, the second pipe 214, or both, may not be mitered pipe portions (e.g., they may be cut perpendicular to a longitudinal axis at a location where their diameter is not changing). The mitered pipe portion 1014 can be mitered in the sense that it is cut at a location where its diameter is changing, cut in a way other than at a plane perpendicular to the longitudinal axis, or both.

The mitered pipe portion 1014 can be a piece of pipe with a changing diameter (e.g., the end interfacing with the first pipe 212 can have a larger diameter than the end interfacing with the second pipe 214). The mitered pipe portion 1014 can be cut from a piece of pipe with a changing diameter (e.g., the mitered pipe portion 1014 can extend farther towards the first pipe 212, the second pipe 214, or both, before being cut), or can be manufactured in the configuration of FIG. 10 (e.g., the mitered pipe portion 1014 is not cut from a longer piece of size varying pipe).

FIG. 10 shows that the pipe joint insert 220a, the pipe joint insert 220b, or both, can be mitered pipe joint inserts (e.g., the outer diameter of the pipe joint insert may not be cylindrical), which can be configured to match a shape of the inner diameter of the respective pipe portions (e.g., the pipe joint insert 220a can be configured to match a shape of the inner diameter of the first pipe 212 and the mitered pipe portion 1014 that the pipe joint insert 220a contacts). For example, the pipe joint insert 220a and/or the pipe joint insert 220b may not be straight. One or more of the pipe joint insert 220a or the pipe joint insert 220b can be configured similarly to other pipe joint inserts 220 discussed herein, such as discussed with respect to one or more of FIG. 2, FIG. 3, or FIG. 4, or can differ in one or more ways.

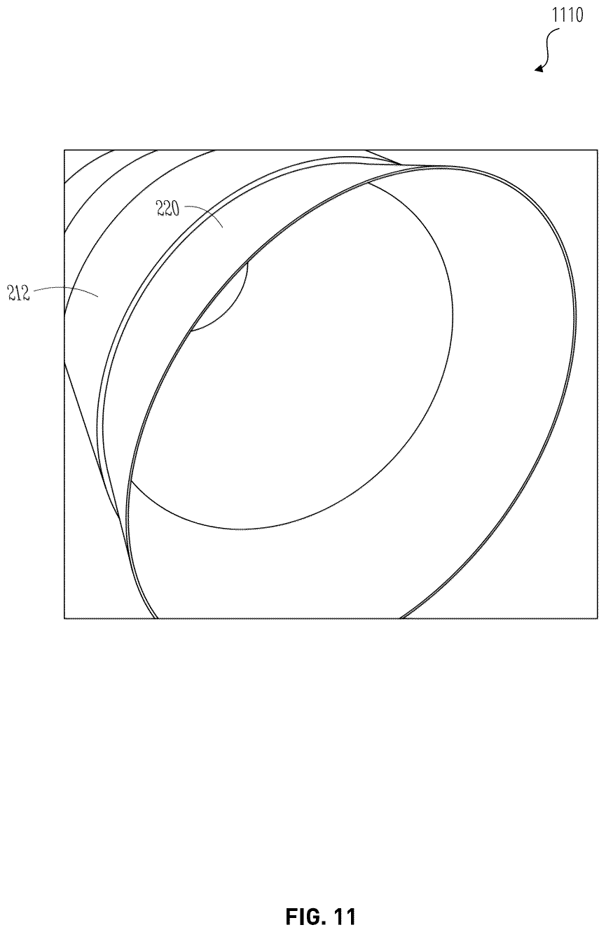

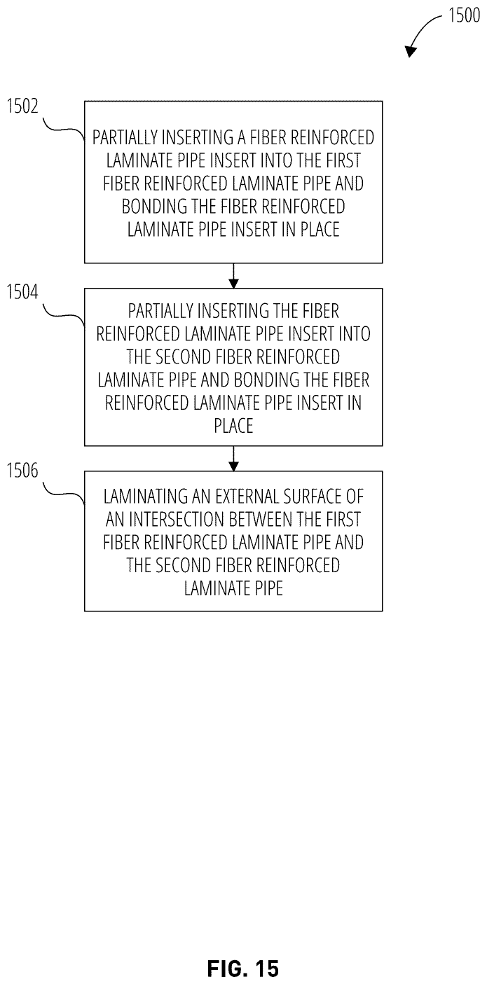

FIG. 11-FIG. 14 show an example of forming a pipe joint 210. FIG. 15 shows an example of portions of a method 1500 for forming a pipe joint 210. With reference to FIG. 15 and the supporting views in FIG. 11 through FIG. 14, the method 1500 can include a method of joining a first fiber reinforced laminate pipe to a second fiber reinforced laminate pipe (e.g., joining the first pipe 212 to the second pipe 214). At step 1502, a fiber reinforced laminate pipe insert can be partially inserted into the first fiber reinforced laminate pipe. The fiber reinforced laminate pipe insert can be bonded to the fiber reinforced laminate pipe insert, which can include bonding the fiber reinforced laminate pipe insert in place. FIG. 11 shows the pipe joint insert 220 partially inserted into the first pipe 212 and bonded to the first pipe 212.

FIG. 11 shows a fiber reinforced laminate pipe joint intermediate 1110. The pipe joint intermediate 1110 shown in FIG. 11 can include a pipe joint insert 220 and a first pipe 212. The pipe joint intermediate 1110 can represent an intermediate configuration in the process of building a pipe joint 210, such as the pipe joint 210 of FIG. 1. FIG. 11 shows that the pipe joint insert 220 can be partially inserted into the first pipe 212 and bonded in place. A portion of the pipe joint insert 220 can extend outside of the first pipe 212. This portion of the pipe joint insert 220 can later be inserted into a second pipe 214. In an example of a pipe joint intermediate 1110, the portion of the pipe joint insert 220 extending outside of the first pipe 212 is not inside the second pipe 214. For example, the pipe joint insert 220 may not have been inserted into the second pipe 214 yet. In an example, a bonding agent bonding the pipe joint insert 220 to the first pipe 212 is cured, which can include being cured before the pipe joint insert 220 is inserted into the second pipe 214.

At step 1504, the fiber reinforced laminate pipe insert can be partially inserted into the second fiber reinforced laminate pipe. In some examples, this may include positioning the second fiber reinforced laminate pipe over the portion of the insert extending out of the first fiber reinforced laminate pipe. The fiber reinforced laminate pipe insert can be bonded to the second fiber reinforced laminate pipe, which can include bonding the fiber reinforced laminate pipe insert in place. The pipe joint insert 220 can be partially inserted into the second pipe 214 and bonded to the second pipe 214.

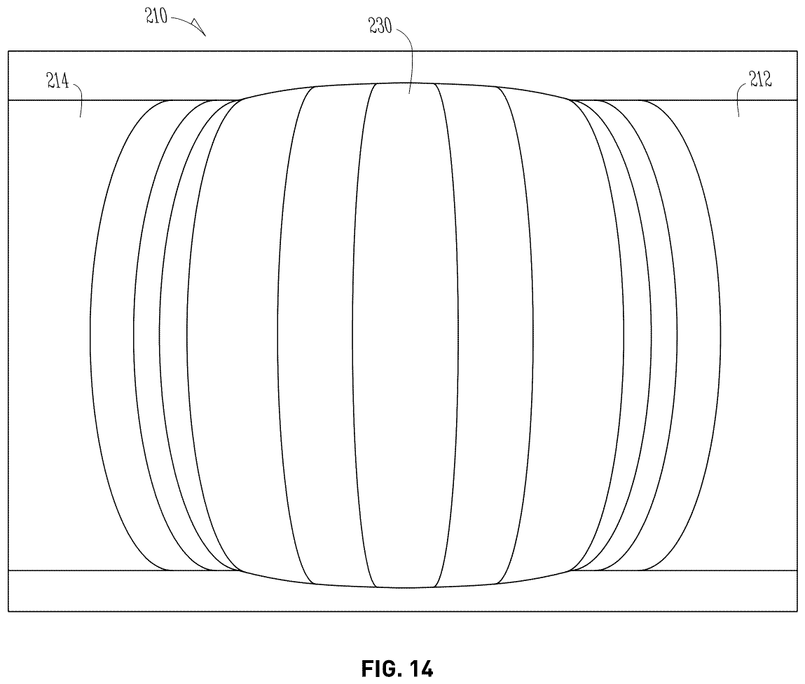

At step 1506, an external surface of an intersection between the first fiber reinforced laminate pipe and the second fiber reinforced laminate pipe can be laminated. FIG. 13 shows an example of laminating the intersection between the first fiber reinforced laminate pipe and the second fiber reinforced laminate pipe. Step 1506 can include applying a resin 1302 to the pipe joint 210 and wrapping the pipe joint 210 in fiber or fiber reinforced fabric 1304. FIG. 14 shows the completed pipe joint 210, including the external lamination 230.

In an example, the method 1500 can be performed with respect to one or more of the pipe joints 210 discussed with respect to FIG. 5 through FIG. 10. For example, as discussed above, the second pipe can include a fitting (e.g., the elbow 514, the Tee 614, the reducer 714). In an example, one or more of the first pipe or the second pipe can include a mitered pipe portion (e.g., the first pipe 212, the mitered pipe portion 814, or the second pipe 214 of FIG. 8; the first pipe 212 or the second pipe 214 of FIG. 9; the first pipe 212, the mitered pipe portion 1014, or the second pipe 214 of FIG. 10). The method of construction of a mitered pipe joint 210 can be similar to the method of construction of a straight pipe joint, or can differ in one or more ways.

The method 1500 can include allowing a bonding agent holding the fiber reinforced pipe joint insert in place within the first fiber reinforced laminate pipe applied in step 1502 to cure before partially inserting the fiber reinforced laminate pipe insert into the second fiber reinforced laminate pipe at step 1504. The method 1500 can include shaping (e.g., sanding, grinding, cutting, or otherwise removing material) the cured bonding agent before partially inserting the fiber reinforced laminate pipe insert into the second fiber reinforced laminate pipe. For example, the cured bonding agent can be sanded, such as so the bonding agent does not prevent the pipe joint insert 220 from inserting to a desired depth within the second pipe 214. The cured bonding agent inside the first pipe 212 can be sanded, such as to reduce an effect the bonding agent has on a flow of fluid through the pipe joint 210.

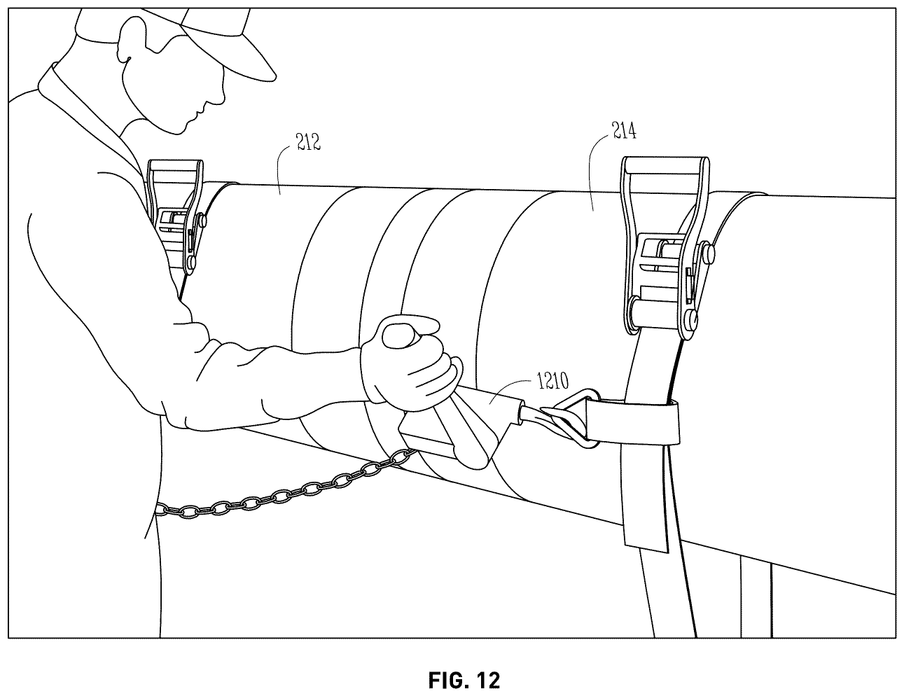

The method 1500 can include applying a clamping force, such as to hold the fiber reinforced laminate pipe insert into the first pipe (e.g., at step 1502), to hold the first fiber reinforced laminate pipe against the second fiber reinforced laminate pipe (e.g., at step 1504), or both. FIG. 12 shows a clamping system 1210, that can be configured to apply a clamping force to hold the first pipe 212 against the second pipe 214. This can reduce a size of the pipe interface 216, help with alignment of the pipe joint 210, or both.

The method 1500 can include using an elongated swabbing instrument to remove excess bonding agent introduced from bonding the fiber reinforced laminate pipe insert to the second fiber reinforced laminate pipe. For example, the elongated swabbing instrument can allow for the removal of excess bonding agent within the pipe, but from an area outside the first fiber reinforced laminate pipe and second fiber reinforced laminate pipe. A worker can have access to the pipe joint insert 220 during step 1502, but following step 1504, the pipe joint insert 220 can be positioned in the middle of a long stretch of pipe (e.g., in the middle of a 40 foot pipe section formed by two 20 foot pipes). The elongated swabbing instrument can include a cloth attached to a pole that is sufficiently long to reach the pipe joint insert 220 from outside the first pipe 212 and the second pipe 214. The elongated swabbing instrument can be used to remove excess bonding agent before the bonding agent cures.

In an example, one or more of the first pipe 212, the second pipe 214, or the pipe joint insert 220 can be dry fit before applying a bonding agent. For example, a dry fit of the entire joint (e.g., without bonding agent and the external lamination 230) can be performed. One or more portions to the first pipe 212, the second pipe 214, or the pipe joint insert 220 can be sanded or otherwise prepared to better interact with the bonding agent. Prior to applying the external lamination 230 at step 1506, a bevel can be cut in one or more of the first pipe 212 or the second pipe 214 near the pipe interface 216, such as can allow the external lamination 230 to enter the pipe interface 216, which can strengthen or otherwise tailor a property of the pipe joint 210.

The shown order of steps is not intended to be a limitation on the order the steps are performed in. In an example, two or more steps may be performed simultaneously or at least partially concurrently.

The following, non-limiting examples, detail certain aspects of the present subject matter to solve the challenges and provide the benefits discussed herein, among others.

### EXAMPLES

Example 1 is a fiber reinforced laminate pipe joint, the pipe joint comprising: a first pipe; a second pipe, wherein the first pipe and the second pipe are fiber reinforced laminate pipes; and a pipe joint insert, partially inserted inside the first pipe and partially inserted inside the second pipe, wherein the pipe joint insert is bonded to the first pipe and the second pipe, wherein the pipe joint insert includes a fiber reinforced laminate, wherein a bonding agent in the fiber reinforced laminate of the pipe joint insert is distinct from a bonding agent used to bond the pipe joint insert to the first pipe.

In Example 2, the subject matter of Example 1 optionally includes an external lamination partially covering the first pipe and partially covering the second pipe.

In Example 3, the subject matter of any one or more of Examples 1-2 optionally include wherein the pipe joint insert has an outer diameter that is configured to interface with an inner diameter of the first pipe and an inner diameter of the second pipe.

In Example 4, the subject matter of Example 3 optionally includes wherein the pipe joint insert includes a mitered pipe joint insert.

In Example 5, the subject matter of any one or more of Examples 1-4 optionally include wherein the bonding agent in the pipe joint insert is fully cured before the pipe joint insert is used in the pipe joint.

In Example 6, the subject matter of any one or more of Examples 1-5 optionally include wherein a fiber in the fiber reinforced laminate includes one or more of fiberglass or carbon fiber.

In Example 7, the subject matter of any one or more of Examples 1-6 optionally include wherein an inner diameter of the first pipe and the second pipe is less than 30 inches.

In Example 8, the subject matter of any one or more of Examples 1-7 optionally include a support member, configured to support the pipe joint insert during the forming of the pipe joint, wherein the support member is removable after the pipe joint is formed.

In Example 9, the subject matter of any one or more of Examples 1-8 optionally include wherein the first pipe and the second pipe have a same inner diameter.

In Example 10, the subject matter of Example 9 optionally includes wherein the first pipe and the second pipe have an inner diameter that is substantially consistent across a longitudinal length of the pipe joint and for a specified margin on either side of the pipe joint.

Example 11 is a fiber reinforced laminate pipe joint intermediate, the pipe joint intermediate comprising: a first fiber reinforced laminate pipe; and a fiber reinforced laminate pipe insert, an outer diameter of a radially outer surface of the fiber reinforced laminate pipe insert configured to interface with an inner diameter of the first fiber reinforced laminate pipe, wherein the fiber reinforced laminate pipe insert is partially inserted into the first fiber reinforced laminate pipe and bonded in place, wherein a portion of the fiber reinforced laminate pipe insert extends outside of the first fiber reinforced laminate pipe.

In Example 12, the subject matter of Example 11 optionally includes wherein the pipe joint insert is circular in cross-section.

In Example 13, the subject matter of any one or more of Examples 11-12 optionally include wherein the pipe joint insert includes a mitered pipe joint insert.

In Example 14, the subject matter of any one or more of Examples 11-13 optionally include wherein the portion of the fiber reinforced laminate pipe insert extending outside of the first fiber reinforced laminate pipe is not inside a second fiber reinforced laminate pipe.

In Example 15, the subject matter of Example 14 optionally includes wherein a bonding agent bonding the fiber reinforced laminate pipe insert to the first fiber reinforced laminate pipe is cured.

Example 16 is a method of joining a first fiber reinforced laminate pipe to a second fiber reinforced laminate pipe, the method comprising: partially inserting a fiber reinforced laminate pipe insert into the first fiber reinforced laminate pipe and bonding the fiber reinforced laminate pipe insert in place; and partially inserting the fiber reinforced laminate pipe insert into the second fiber reinforced laminate pipe and bonding the fiber reinforced laminate pipe insert in place.

In Example 17, the subject matter of Example 16 optionally includes laminating an external surface of an intersection between the first fiber reinforced laminate pipe and the second fiber reinforced laminate pipe.

In Example 18, the subject matter of Example 17 optionally includes laminating the external surface of an intersection between the first fiber reinforced laminate pipe and the second fiber reinforced laminate pipe after the fiber reinforced laminate pipe insert has been bonded to the first fiber reinforced laminate pipe and the second fiber reinforced laminate pipe and a bonding agent has cured.

In Example 19, the subject matter of any one or more of Examples 16-18 optionally include allowing a bonding agent holding the fiber reinforced laminate pipe insert in place within the first fiber reinforced laminate pipe to cure before partially inserting the fiber reinforced laminate pipe insert into the second fiber reinforced laminate pipe.

In Example 20, the subject matter of Example 19 optionally includes applying a clamping force to hold the first fiber reinforced laminate pipe against the second fiber reinforced laminate pipe.

In Example 21, the subject matter of any one or more of Examples 19-20 optionally include shaping the cured bonding agent before partially inserting the fiber reinforced laminate pipe insert into the second fiber reinforced laminate pipe.

In Example 22, the subject matter of Example 21 optionally includes using an elongated swabbing instrument to remove excess bonding agent from bonding the fiber reinforced laminate pipe insert to the second fiber reinforced laminate pipe, wherein the elongated swabbing instrument allows for the removal of excess bonding agent from an area outside the first fiber reinforced laminate pipe and second fiber reinforced laminate pipe.

In Example 23, the subject matter of any one or more of Examples 16-22 optionally include wherein the fiber reinforced laminate pipe insert includes a mitered fiber reinforced laminate pipe insert.

Example 24 is at least one machine-readable medium including instructions that, when executed by processing circuitry, cause the processing circuitry to perform operations to implement of any of Examples 1-23.

Example 25 is an apparatus comprising means to implement of any of Examples 1-23.

Example 26 is a system to implement of any of Examples 1-23.

Example 27 is a method to implement of any of Examples 1-23.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific examples that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the terms “or” and “and/or” are used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. A fiber reinforced laminate pipe joint, the pipe joint comprising:
a first pipe;
a second pipe, wherein the first pipe and the second pipe are fiber reinforced laminate pipes; and
a pipe joint insert, partially inserted inside the first pipe and partially inserted inside the second pipe, wherein the pipe joint insert is bonded to the first pipe and the second pipe, wherein the pipe joint insert includes a fiber reinforced laminate, wherein a bonding agent in the fiber reinforced laminate of the pipe joint insert is distinct from a bonding agent used to bond the pipe joint insert to the first pipe.

2. The pipe joint of claim 1, further comprising an external lamination partially covering the first pipe and partially covering the second pipe.

3. The pipe joint of claim 1, wherein the pipe joint insert has an outer diameter that is configured to interface with an inner diameter of the first pipe and an inner diameter of the second pipe.

4. The pipe joint of claim 3, wherein the pipe joint insert includes a mitered pipe joint insert.

5. The pipe joint of claim 1, wherein the bonding agent in the pipe joint insert is fully cured before the pipe joint insert is used in the pipe joint.

6. The pipe joint of claim 1, wherein a fiber in the fiber reinforced laminate includes one or more of fiberglass or carbon fiber.

7. The pipe joint of claim 1, wherein an inner diameter of the first pipe and the second pipe is less than 30 inches.

8. The pipe joint of claim 1, further comprising a support member, configured to support the pipe joint insert during the forming of the pipe joint, wherein the support member is removable after the pipe joint is formed.

9. The pipe joint of claim 1, wherein the first pipe and the second pipe have a same inner diameter.

10. The pipe joint of claim 9, wherein the first pipe and the second pipe have an inner diameter that is substantially consistent across a longitudinal length of the pipe joint and for a specified margin on either side of the pipe joint.

11. A fiber reinforced laminate pipe joint intermediate, the pipe joint intermediate comprising:
a first fiber reinforced laminate pipe; and
a fiber reinforced laminate pipe insert, an outer diameter of a radially outer surface of the fiber reinforced laminate pipe insert configured to interface with an inner diameter of the first fiber reinforced laminate pipe, wherein the fiber reinforced laminate pipe insert is partially inserted into the first fiber reinforced laminate pipe and bonded in place, wherein a portion of the fiber reinforced laminate pipe insert extends outside of the first fiber reinforced laminate pipe.

12. The pipe joint intermediate of claim 11, wherein the pipe joint insert is circular in cross-section.

13. The pipe joint intermediate of claim 11, wherein the pipe joint insert includes a mitered pipe joint insert.

14. The pipe joint intermediate of claim 11, wherein the portion of the fiber reinforced laminate pipe insert extending outside of the first fiber reinforced laminate pipe is not inside a second fiber reinforced laminate pipe.

15. The pipe joint intermediate of claim 14, wherein a bonding agent bonding the fiber reinforced laminate pipe insert to the first fiber reinforced laminate pipe is cured.

16. A method of joining a first fiber reinforced laminate pipe to a second fiber reinforced laminate pipe, the method comprising:
partially inserting a fiber reinforced laminate pipe insert into the first fiber reinforced laminate pipe and bonding the fiber reinforced laminate pipe insert in place; and
partially inserting the fiber reinforced laminate pipe insert into the second fiber reinforced laminate pipe and bonding the fiber reinforced laminate pipe insert in place.

17. The method of claim 16, comprising:
laminating an external surface of an intersection between the first fiber reinforced laminate pipe and the second fiber reinforced laminate pipe.

18. The method of claim 17, comprising:
laminating the external surface of an intersection between the first fiber reinforced laminate pipe and the second fiber reinforced laminate pipe after the fiber reinforced laminate pipe insert has been bonded to the first fiber reinforced laminate pipe and the second fiber reinforced laminate pipe and a bonding agent has cured.

19. The method of claim 16, comprising:
allowing a bonding agent holding the fiber reinforced laminate pipe insert in place within the first fiber reinforced laminate pipe to cure before partially inserting the fiber reinforced laminate pipe insert into the second fiber reinforced laminate pipe.

20. The method of claim 19, comprising:
applying a clamping force to hold the first fiber reinforced laminate pipe against the second fiber reinforced laminate pipe.

21. The method of claim 19, comprising:
shaping the cured bonding agent before partially inserting the fiber reinforced laminate pipe insert into the second fiber reinforced laminate pipe.

22. The method of claim 21, comprising:
using an elongated swabbing instrument to remove excess bonding agent from bonding the fiber reinforced laminate pipe insert to the second fiber reinforced laminate pipe, wherein the elongated swabbing instrument allows for the removal of excess bonding agent from an area outside the first fiber reinforced laminate pipe and second fiber reinforced laminate pipe.

23. The method of claim 16, wherein the fiber reinforced laminate pipe insert includes a mitered fiber reinforced laminate pipe insert.
